(19) United States
(12) Patent Application Publication
(10) Pub. No.: US 2006/0085600 A1
(43) Pub. Date: Apr. 20, 2006

(54) Cache memory system

(76) Inventors: Takanori Miyashita, Takatsuki-shi (JP); Kohsaku Shibata, Takatsuki-shi (JP); Shintaro Tsubata, Komatsu-shi (JP)

Correspondence Address: MCDERMOTT WILL & EMERY LLP, 600 13TH STREET, N.W., WASHINGTON, DC, 20005-3096, US

(21) Appl. No.: 11/242,002

(22) Filed: Oct. 4, 2005

(30) Foreign Application Priority Data
Oct. 20, 2004 (JP) 2004-305256

(51) Int. Cl. G06F 12/00

(52) U.S. Cl. 711/128; 711/143

(57) ABSTRACT

Provided is a cache memory system which, in a system having a plurality of masters, effectively utilizes a bus band. The cache memory system comprises: a cache memory; a bus load judging device for performing judgment of a state of a bus that is connected to a recording device in which cache-target data of the cache memory is stored; and a replace-way controller for controlling a replacing form of the cache memory according to a result of judgment performed by the bus load judging device.

### BACKGROUND OF THE INVENTION

1. Field of the Invention

The present invention relates to a cache memory system and, particularly, to a replace technique which employs write-back of a multi-way set associative system.

2. Description of the Related Art

It is known in a cache memory system that two structures in the followings enable to determine which data block is to be replaced when there is a cache error.
(1) a structure for selecting data block according to access state
(2) a structure for selecting data block by fixed priority according to a state of cache memory

Examples of the structure (1) may be a structure (referred to as an LRU (Least Recently Used) structure) which replaces a data block that was accessed least recently, and a structure (referred to as FIFO (First In First Out) structure) which replaces a data block that was replaced least recently. Among the methods for achieving the structure (2), there is a structure which replaces a data block of exclusive-discordant.

Further, as a structure in which bus traffic is improved in the replace processing, there is a structure where the above-described structures (1) and (2) are switcheably used as disclosed in Japanese Patent Unexamined Publication No. 11-39218 (pp. 3-4, FIG. 1). This structure will be referred to as a related art hereinafter.

In the related art, a counter is used for counting the number of entry of exclusive-discordant of the cache memory and, according to a counted value of the counter, the method for replacing the cache memory is switched as necessary. Specifically, when the entry number of the exclusive discordant of the cache memory is smaller than the counted value, the replace processing is carried out by the structure (2) and, when it is larger, the replace processing is carried out by the structure (1).

Therefore, it is possible to avoid having the entry, which is exclusive-discordant in the cache memory, as the target of the replacement as much as possible. With this, the number of write-back is reduced thus improving the bus traffic. The write-back means to write back data to external memories when the entry to be replaced is exclusive-discordant, which is also referred to as copy-back.

However, in the related art, although it enables to reduce the number of write-back by switching the above-described structures (1) and (2), there is no measure taken for bus load. Thus, in a system with a plurality of masters present, when the bus load is large because another master is in use of the bus, the replace processing along with the write-back may be carried out. Therefore, bus traffic may increase locally.

In a processor such as a DSP (Digital Signal Processor), which requires real-time processing, the bus traffic becomes a factor for critical processing delay. Further, in general, when designing the bus, width of the bus is designed by assuming the worst bas traffic case. Therefore, for embodying the conventional structure in which the bus traffic is insufficiently arranged, it is necessary to set a bus width with a margin when designing.

### SUMMARY OF THE INVENTION

An object of the present invention is to have uniform bus traffic with the consideration of the bus load.

In order to overcome the aforementioned problems, as the main basic structure of the present invention, the cache memory system and the moving picture processor of the present invention comprise: a cache memory; a bus load judging device for performing judgment of a state of a bus that is connected to a recording device in which cache-target data of the cache memory is stored; and a replace-way controller for controlling a replacing form of the cache memory according to a result of judgment performed by the bus load judging device.

This structure enables to change the replacing form according to the bus load so that the bus traffic can be made uniform. For example, under a state where, in a system having a plurality of masters, there is a bus load generated since another master is using the bus, selected is a replacement processing form without write-back having small bus load. In the meantime, under a state with no bus load, selected is a replacement processing form with write-back having a large load. Thereby, the bus traffic becomes uniform. In that case, the cache memory is preferable to be a cache memory of a multi-way set associative system.

It is preferable that the basic structure of the present invention as described above further comprise the following structures. That is, it is preferable that the bus load judging device set validity/invalidity of load of the bus according to the judgment of the bus state, and that the replace-way controller control the replacing form of the cache memory according to a set state of the bus load judging device.

Further, it is preferable that the replace-way controller perform replacement by giving priority to a way which is not exclusive-discordant when the bus load is judged as valid by the bus load judging device, while performing replacement by giving priority to a way which is exclusive-discordant when the bus load is judged as invalid. With this, at the time of replacing the cache, it is possible to select the replacing form without write-back having a small bus load when there is the bus load being generated. Further, when there is no bus load, the bus can be utilized without a waste by giving priority to perform the replacing form with write-back having a large bus load.

Furthermore, it is preferable that the bus load judging device comprise: a bus load information holding unit which gathers and holds bus request reserved number of the bus; a bus load judging condition setting unit for setting a condition for judging (referred to as judging condition herein after) the bus load in the bus request reserved number which is being gathered and held; and a comparator for comparing the bus request reserved number held in the bus load information holding unit and the judging condition set in the bus load judging condition setting unit and, according to a result of comparison performed thereby, sets validity/invalidity of the load of the bus. With this, it becomes possible to detect the bus load only by the information on the bus request reserved number.

It is preferable that the comparator judge the bus load as valid when the bus request reserved number is larger or equal to the judging condition, and judges as invalid for other cases.

Furthermore, it is desirable that the bus load judging device comprise a bus load presence information setting unit which can set presence of the bus load from outside of the device, and that the bus load judging device judge validity/invalidity of the bus load according to a set state of the bus load presence information setting unit. With this, it becomes possible to change the replacing form at the optimum timing by having a user who writes a program sets the validity/invalidity of the bus load. Thus, the bus can be effectively utilized.

Moreover, it is preferable that the bus load presence information setting unit set presence of the bus load according to information indicating validity or invalidity of the bus load, which is written on a program.

Further, it is preferable that the cache memory comprises a plurality of cache memory lines and that, under a state where there are a plurality of dirty bits indicating exclusive-discordant in each of the cache memory lines of the cache memory, the replace-way controller perform replacement by giving priority to a way having less valid number of the dirty bits when the bus load is judged as valid by the bus load judging device, while performing replacement by giving priority to a way having more valid number of the dirty bits when judged as invalid. With this, at the time of replacing the cache, it becomes possible to select the way form having still smaller bus load under the state where there is the bus load generated and there is only the way of exclusive-discordant as the replaceable way. Also, it becomes possible to select the replace-way form which utilizes the bus to a still larger extent when there is no bus load.

Moreover, it is preferable that the cache memory comprise a plurality of cache memory lines and that, under a state where burst transfer can be executed in the cache memory, the replace-way controller change a way to be replaced in accordance with setting of the burst transfer of the cache memory and distributions of valid dirty bits when there are a plurality of dirty bits indicating exclusive-discordant in each of the cache memory lines and numbers of the valid dirty bits are consistent with each other. With this, even under the state where the numbers of the valid dirty bits are the same at the time of selecting the replace-way, the following processing becomes possible by taking the burst transfer into account. That is, when there is a bus load, it is possible to select the replacing form having the still smaller bus load and, when there is no bus load, it is possible to select the replacing form which utilizes the bus to a still larger extent.

With the moving picture processor of the present invention having the above-described structures, it is possible to prevent an increase of a local bus traffic, i.e. a local memory access latency (waiting time) which causes a system breakdown. Therefore, stable moving picture processing can be executed.

As described above, with the present invention, it is possible to change the replacing structure of the cache memory in accordance with the bus load. That is, when there is a bus load, the replacement processing with small bus load is performed. When there is no bus load, the replacement processing with a large bus load is performed. Thereby, the bus can be effectively utilized and the local bus traffic can be improved. Thus, the bus traffic can be made uniform. Furthermore, since the bus load is made uniform, it is possible at the time of designing the bus width to set the optimum bus width. Moreover, with the moving picture processor, it is possible to prevent the system failure such as missing of a frame, etc.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the structure of a cache memory system according to a first embodiment of the present invention;

FIG. 2 is a block diagram for showing the structure of a cache memory system according to a second embodiment of the present invention;

FIG. 3 is a functional block diagram for showing the structure of a compiler according to each embodiment of the present invention;

FIG. 4 is an example of a program code for setting bus load existence information;

FIG. 5 is a block diagram for showing the structure of a cache memory according to each embodiment of the present invention;

FIG. 6 is an illustration for showing ON/OFF states of dirty bits in a dirty bit storage unit when there are four dirty bits in a cache memory line of a cache memory 1;

FIG. 7 is a flowchart of replace-way selecting processing of a replace-way control unit according to each embodiment of the present invention;

FIG. 8 is a flowchart of replacement processing of the cache memory system according to each embodiment of the present invention;

FIG. 9 is an illustration for showing time sequence of replacement processing in a system which uses three masters with an ordinal cache memory system, and a common bus;

FIG. 10 is an illustration for showing time sequence of replacement processing in a system which uses three masters with an ordinal cache memory system, and a common bus;

FIG. 11 is a structural block diagram of a moving picture processor which comprises the cache memory system of the present invention;

FIG. 12 is a flowchart of moving picture processing performed by the moving picture processor which comprises the cache memory system of the present invention; and

FIG. 13 is an illustration for describing an effect of preventing failure in the moving picture processing achieved by the moving picture processor to which the cache memory system of the present invention is mounted.

### DETAILED DESCRIPTION OF THE INVENTION

Embodiments of the cache memory system according to the present invention will be described in detail by referring to the accompanying drawings.

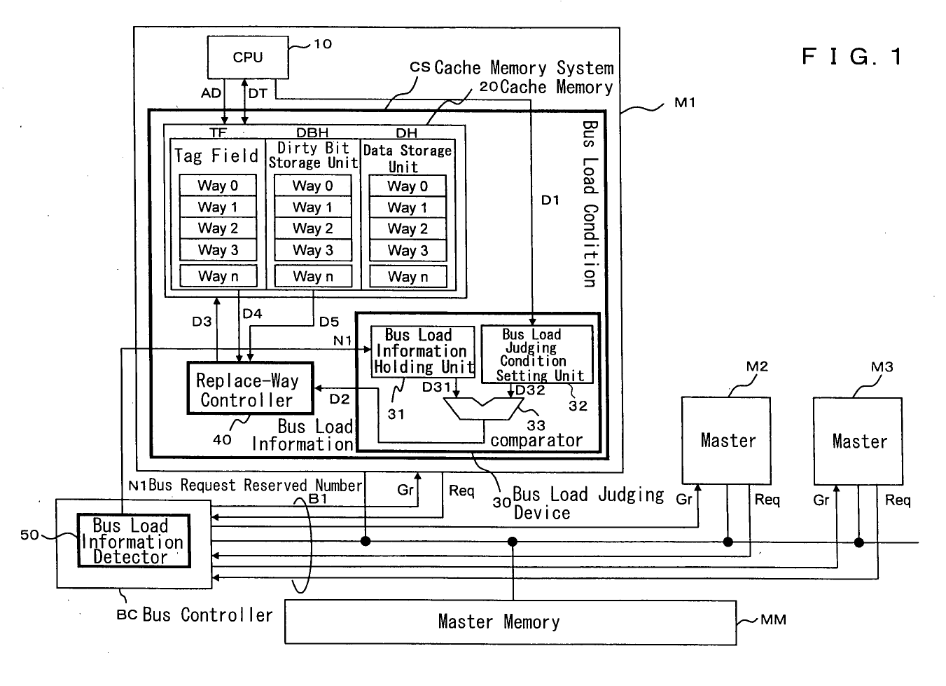

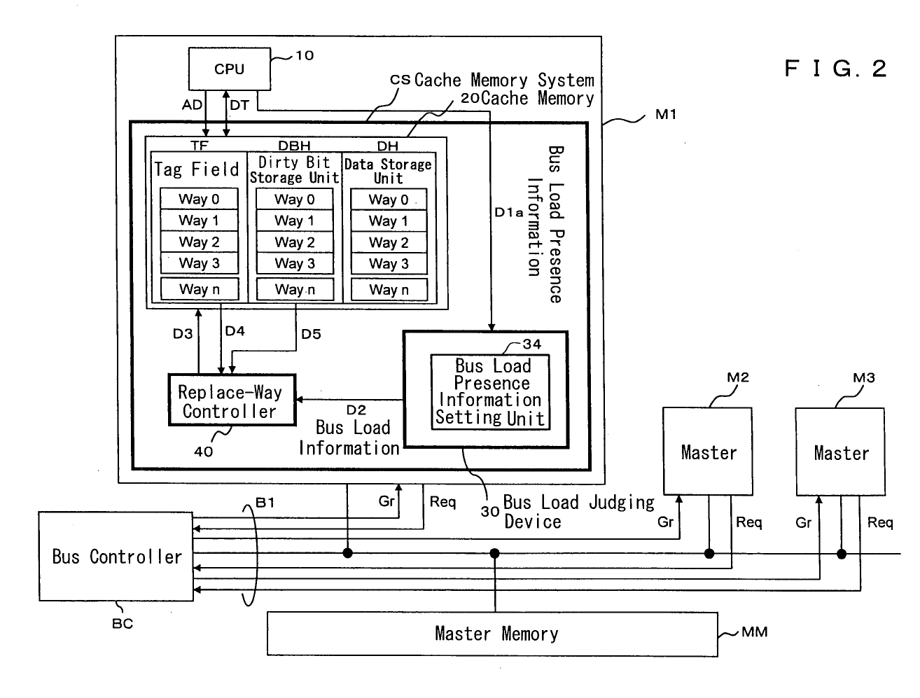

FIG. 1 is a block diagram for showing the structure of the cache memory system according to a first embodiment of the present invention. FIG. 2 is a block diagram for showing the structure of the cache memory system according to a second embodiment of the present invention.

The cache memory system of FIG. 1 comprises: three masters M1-M3, a bus controller BC having a bus load information detector 50, a master memory MM, and a bus B1. The master M1 carries a CPU 10 and a cache memory system CS. The cache memory system CS comprises a cache memory 20 of a write-back system, a bus load judging device 30, and a replace-way controller 40. The cache memory system CS is an n-way set associative system. By way of example, the cache memory system CS of this embodiment employs 4-way set associative system.

The cache memory 20 comprises tag fields TF for each way, a dirty bit storage unit DBH, and a data storage unit DH. The bus load judging device 30 comprises: a bus load information holding unit 31 which holds bus load information by obtaining a bus request reserved number N1 from a bus load information detector 50 of the bus controller BC; a bus load judging condition setting unit 32 for setting bus load condition D1 according to a command of the CPU 10; and a comparator 33 for comparing the value of the bus load information holding unit 31 and the value of the bus load judging condition setting unit 32. The replace-way controller 40 changes the replacing method of the cache memory 20 in accordance with bus load information D2 which is a result of judgment by the bus load judging device 30.

In the drawing, AD is an address from the CPU 10, and DT is data. D3 is a way number, D4 is tag information, and D5 is dirty bit information. Req is a data request signal, and Gr is an enabling signal.

In the cache memory system of FIG. 2, the bus load judging device 30 is provided with a bus load presence information setting unit 34 which sets bus load presence information D1a according to a command of the CPU 10. There is no bus load information detector 50 provided in the structure of FIG. 2, so that the bus request reserved number N1 is irrelevant to the structure of FIG. 2. Other configuration is the same as that of FIG. 1. Thus, description thereof will be omitted by simply applying the same reference numerals to the same components.

(Bus Load Detector)

In the bus load judging device 30 of FIG. 1, the comparator 33 compares a held value D31 of the bus load information holding unit 31 and a condition setting value D32 of the bus load judging condition setting unit 32, and determines the bus load according to a result of the comparison. When the held value D31 is equal to or larger than the condition setting value D32, the bus load is judged as valid. In the meantime, when the held value D31 is smaller than the condition setting value D32, the bus load is judged as invalid.

For example, in the case where the bus request reserved number N1 at the time of cache error is “3” and the held value D31 is “3” while the condition setting value D32 is set as “1”, the bus load is judged as valid. In the meantime, in the case where the bus request reserved number N1 at the time of cache error is “1” and the held value D31 is “1” while the condition setting value D32 is set as “2”, the bus load is judged as invalid.

In the structure of FIG. 2, a user designates the bus load existence information D1a to the CPU 10, and the CPU 10 sets the bus load existence information D1a to the bus load presence information setting unit 34 of the bus load judging device 30. Thereby, validity/invalidity of the bus load is judged. For example, let's assume that the valid bus load is “1” and invalid bus load is “0”. Under this state, if the user designates the bus load presence information D1a as “1”, the bus load becomes valid. If the user designates the bus load presence information D1a as “0”, the bus load becomes invalid.

(Compiler)

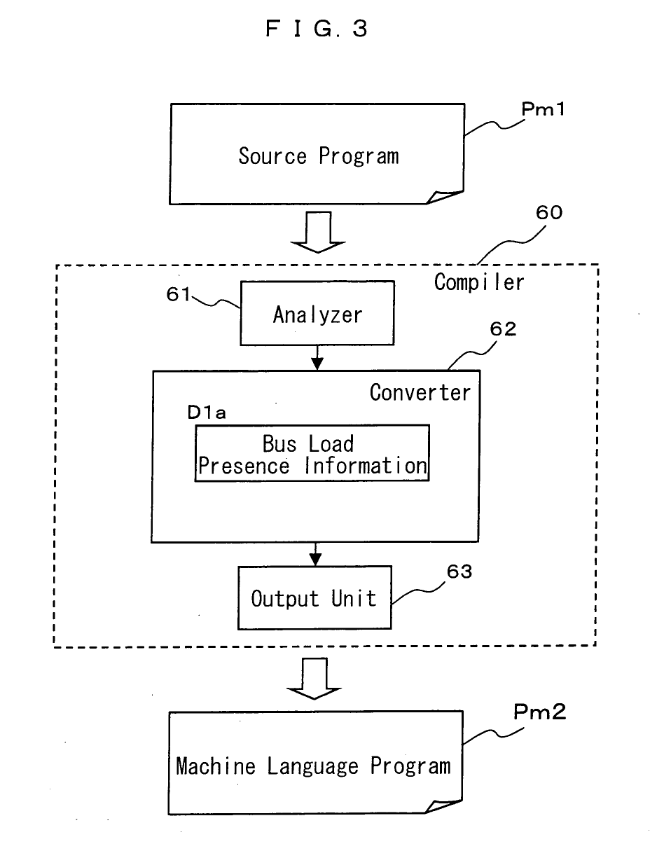

For the user to designate the bus load presence information D1a to the CPU 10, a compiler targeting at the CPU 10 may be used for designating the bus load presence information D1a to the CPU 10. FIG. 3 is a functional block diagram for showing the structure of a compiler 60. The compiler 60 is a cross compiler which converts a source program Pm1 that is written and designated in a high-rank language such as C-language or the like to a machine language Pm2 that is programmed for targeting at the CPU 10. This compiler 60 comprises an analyzer 61, a converter 62, and an output unit 63, which is achieved by a program executed on a computer such as a personal computer or the like.

The analyzer 61 analyzes tokens of the source program Pm1 as a target of compiling and that of the setting (achieved by a programmer) of the bus load presence information D1a designated from the user to the compiler 60. The analyzer 61 transmits the designated setting of the bus load presence information D1a to the converter 62 and the output unit 63 according to the token analysis performed, and converts the program which is the target of compiling into an internal format data.

“Pragma (or pragmatic command)” is a command to the compiler 60, which can be arbitrarily designated (arranged) by the user in the source program Pm1. The compiler 60 designates the bus load presence information by writing (#pragma_bus_res “bus load presence information”) which is a command for setting the bus load presence information.

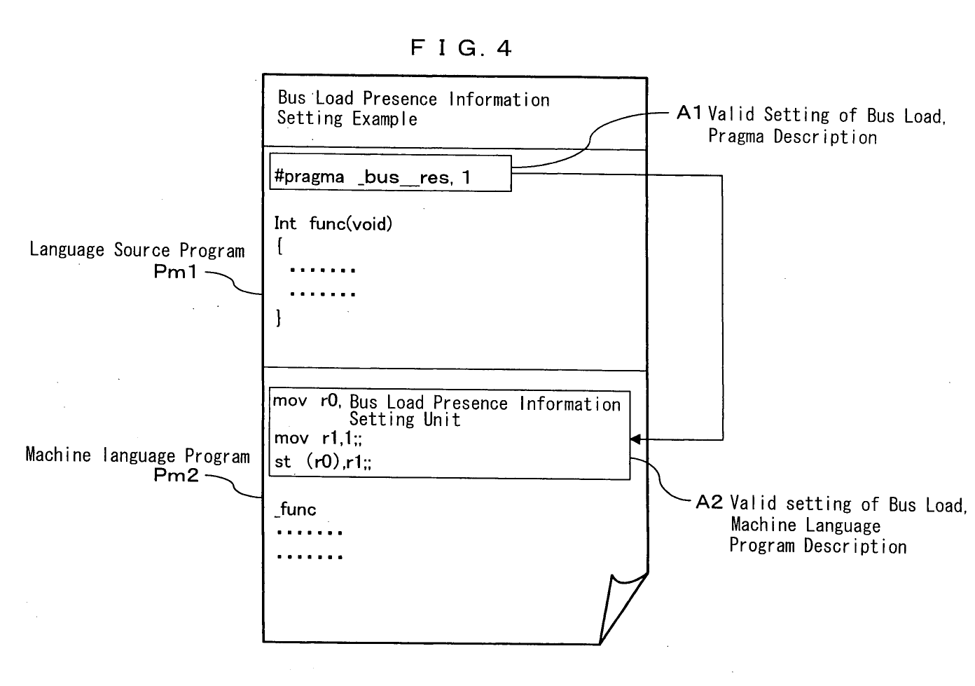

FIG. 4 shows an example of a program code using #pragma_bus_res. In FIG. 4, bus load valid setting pragma description Al of the language source program Pm1 is converted into bus load valid setting machine language program description A2.

As shown in FIG. 4, the language source program Pm1 written as “#pragma_bus_res 1” is converted into a machine language program which gives a command of writing “1” as the bus load presence information to the bus load presence information setting unit 34. By this machine language program, the bus load becomes valid.

Further, the language source program written as “#pragma_bus_res 0” is converted into a machine language program which gives a command of writing “0” as the bus load presence information to the bus load presence information setting unit 34. By this machine language program, the bus load becomes invalid.

A flow of setting the bus load presence information D1a to the bus load presence information setting unit 34 is set by the user. In this flow, first, “#pragma_bus_res” is written in the language source program Pm1. With this, the bus load presence information is designated by the user to the cache memory system.

Subsequently, the analyzer 61 of the compiler 60 analyzes the designation of the bus load presence information. Then, the converter 62 converts the bus load presence information D1a to the machine language program, and the machine language program Pm2 is outputted from the output unit 63. The machine language program to be outputted is executed by the CPU 10, and the bus load presence information D1a is set in the bus load presence information setting unit 34.

(Cache Memory)

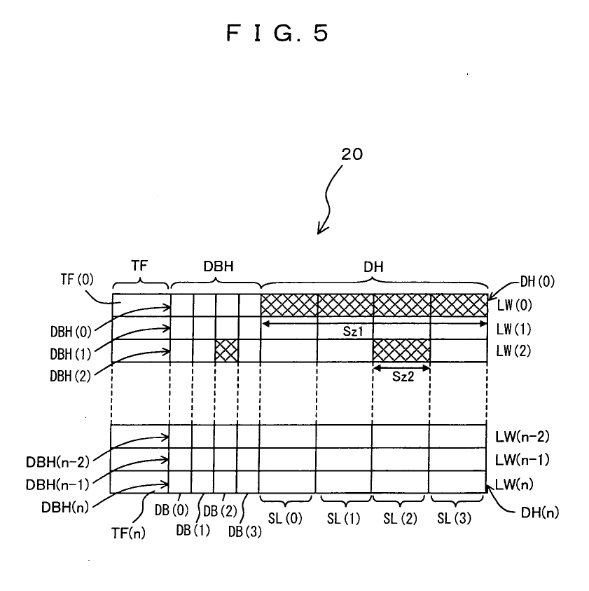

FIG. 5 shows the details of the cache memory 20 which is shown in FIG. 1 and FIG. 2. The cache memory 20 is a cache memory of an N-way set associative system (4-way in this embodiment) having N-number of cache memory sub-lines SL(0)-SL(N−1). N is selected from 2^{q} (q is a natural number), however, N is set as 4 in this embodiment.

The cache memory 20 comprises a plurality of cache memory lines LW(0)-LW(n) where, n is a natural number. The cache memory lines LW(0)-LW(n) are provided for every ways. Each of the cache memory lines LW(0)-LW(n) comprises tag fields TF(0)-TF(n), dirty bit storage units DBH(0)-DBH(n), and data storage units DH(0)-DH(n). One each of the tag fields TF(0)-TF(n), the dirty bit storage units DBH(0)-DBH(n), and the data storage units DH(0)-DH(n) are provided in each of the cache memory lines LW(0)-LW(n). The number added to the end of the code is common to all.

The data size by which data can be stored to the data storage units DH(0)-DH(n) is referred to as a cache memory line size (Sz1), and the data size by which the data can be stored to the cache memory sub-lines SL(0)-SL(3) is referred to as a cache memory sub-line data size (Sz2). For example, as in this embodiment, when the cache memory line size (Sz1) is 128 byte and the number of the cache memory sub-lines SL(0)-SL(3) is four, the cache memory sub-line data size (Sz2) becomes 32 byte.

Each of the dirty bit storage units DBH(0)-DBH(n) stores the same number of dirty bits (four in FIG. 5) as the number of cache memory sub-lines SL(0)-SL(3). Each of the dirty bit storage units DBH(0)-DBH(n) corresponds to each of the cache memory sub-lines SL(0)-SL(3) in the cache memory lines LW(0)-LW(n) to which the dirty bit storage units DBH(0)-DBH(n) are provided. For example, in FIG. 5, the dirty bit DB2 in the dirty bit storage unit DBH(2) of way 2 corresponds to the cache memory sub-line SL(2) of the cache memory line LW2 of the way 2.

The dirty bit is a bit for determining whether or not to write back the currently stored data to a memory of lower level when replacing the data, which is stored in the cache memory lines LW(0)-LW(n), with another data. For example, if the dirty bit is ON, the data stored in the cache memory lines LW(0)-LW(n) is written back.

In the structure of FIG. 5, the dirty bits are in correspondence with the cache memory sub-lines LW(0)-LW(n). Thus, it is judged as necessary to write back the data stored in the cache memory sub-lines SL(0)-SL(3) of the cache memory lines LW(0)-LW(n) where the dirty bit is ON.

The tag fields TF(0)-TF(n) store the tag. The tag carries information for judging whether or not the requested data is stored in the cache memory lines LW(0)-LW(n).

In the cache memory 20 shown in FIG. 5, the cache memory lines LW(0)-LW(n) are divided into a plurality (four in FIG. 5) of the cache memory sub-lines SL(0)-SL(3), and the dirty bits corresponding to the cache memory sub-lines SL(0)-SL(3) are stored in the dirty bit storage units DBH. That is, in the cache memory 20, a plurality of dirty bits are stored in each of the cache memory lines LW(0)-LW(n).

However, instead of the structure shown in FIG. 5, it may be in a structure in which each of the cache memory lines LW(0)-LW(n) is divided per cache memory sub-line, and the dirty bit corresponding to the cache memory sub-line is provided to the dirty storage unit DBH. That is, it may be in a structure in which a single dirty bit is stored in each of the cache memory lines LW(0)-LW(n).

(Replace-Way Selecting Priority)

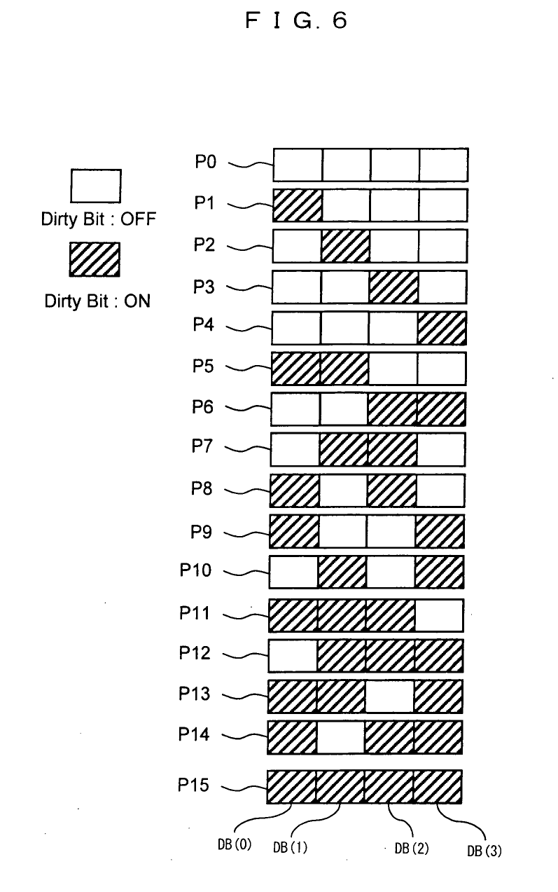

FIG. 6 shows the ON/OFF states of the dirty bits in the dirty bit storage units DBH in the structure of FIG. 5 in which four data bits are stored in each of the cache memory lines LW(0)-LW(n). The replace-way controller 40 determines the replace-way selecting priority according to the state of the dirty bit shown in FIG. 6. The replace-way selecting priority is the data with which the replace-way is determined. The replace-way is the way of the cache memory lines LW(0)-LW(n) to be replaced at the time of replacing the data in the cache memory 20 because of a cache error. As shown in FIG. 6, in the structure where four dirty bits are stored in the dirty bit storage unit DBH, there are sixteen states of P0-P15. Each of the states P0-P15 has the replace-way selecting priority.

(Case of Valid Bus Load)

Described is a selecting method of the replace-way, which is used when the bus load is judged as valid by the bus load judging device 30. In that case, the replace-way is so selected that the bus load for replacing is more reduced. In the state of the dirty bit shown in FIG. 6, the number of ON, i.e. the valid number, increases in order from the state P0 to the state P15. Thus, the transfer amount to be written back at the time of replacement is increased so that the bus load is increased. Therefore, the priority of the replace-way selection goes down from the state P0 to the state P15. In other words, the priority of the state P0 is the highest so that it can be judged as being most likely to be replaced in this state.

In the cache memory system which does not correspond to the burst transfer, each of the sets of states P1-P4, states P5-P10, and states P11-P14 has the same priority. The reason for having such priority is that the valid number of the dirty bits is the same for each set.

In the meantime, the priority becomes as follows in the cache memory system which corresponds to the burst transfer. That is, when the size of transfer data at the time of bust transfer in this system is twice the data size of the cache memory sub-lines SL(0)-SL(3), each set of the states P1-P4, the states P5, P6, and the states P7-P10 comes to have the same priority.

Each set of the states P1-P4 and the states P11-P14 has the same priority since, as in the above-described cache memory system which does not correspond to the burst transfer, the valid number of each dirty bit is the same. However, the priority of the states P5, P6 and that of the states P7-P10, which have the same number of the valid dirty bit, are different from each other because of the following reason.

That is, when the size of the burst transfer is twice the cache memory sub-line, it is necessary to perform the burst transfer twice in the states P7-P10, whereas it requires the burst transfer once in the state P5, P6. Therefore, the bus load at the time of replacement is smaller in the states P5, P6 than in the sates P7-P10. In the case where there are a plurality of ways of the same priority, selection is made in order from the one with the smallest way number.

Further, when there are a plurality of ways with the same priority, it is possible to determine which way to select based on the respective access state of these plural ways with the same priority. In other words, when there are a plurality of ways with the same priority, it is possible to employ systems such as an LRU (Least Recently Used) system that gives the highest priority and replaces the way where the least recently accessed data is stored, and an FIFO (First In First Out) system that gives the highest priority and replaces way where the least recently replaced data is stored. Thereby, it enables to perform the way replace processing considering the time locality so that the hit rate of the cache can be improved.

(Case of Invalid Bus Load)

Described is a selecting method of the replace-way, which is used when the bus load is judged as invalid by the bus load judging device 30. In that case, the replace-way is so selected that the bus can be more effectively used by the replacement. In the state of the dirty bit shown in FIG. 6, the number of ON, i.e. the valid number, increases in order from the state P0 to the state P15. Thus, the transfer amount to be written back is increased at the time of replacement so that the bus load is increased. Therefore, the priority of the replace-way selection goes down from the state P0 to the state P15. In other words, the priority of the state P0 is the highest so that it can be judged as being most likely to be replaced in this state.

In the cache memory system which does not correspond to the burst transfer, each of the sets of states P1-P4, states P5-P10, and states P11-P14 has the same priority. The reason for having such priority is that the valid number of the dirty bits is the same for each set.

In the meantime, the priority becomes as follows in the cache memory system which corresponds to the burst transfer. That is, when the size of transfer data at the time of burst transfer in this system is twice the data size of the cache memory sub-lines SL(0)-SL(3), each set of the states P1-P4, the states P5, P6, and the states P7-P10 has the same priority.

Each of the states P1-P4 and the states P11-P14 has the same priority since, as in the above-described cache memory system which does not correspond to the burst transfer, the valid number of each dirty bit is the same. However, the priority of the states P5, P6 and that of the states P7-P10, which have the same number of the valid dirty bit, are different from each other because of the following reason.

That is, when the size of the burst transfer is twice the cache memory sub-line, it is necessary to perform the burst transfer twice in the states P7-P10, whereas it requires the burst transfer once in the state P5, P6. Therefore, the bus load at the time of replacement is smaller in the states P5, P6 than in the sates P7-P10. In the case where there are a plurality of ways of the same priority, selection is made in order from the one with the smallest way number.

FIG. 6 shows the structure in which four dirty bits are stored in each of the cache memory lines LW(0)-LW(n). However, the structure in which a single dirty bit is stored in each of the cache memory lines LW(0)-LW(n) can also be described by referring to FIG. 6. In the case where a single dirty bit is stored in each of the cache memory lines LW(0)-LW(n) in the structure of FIG. 6, it can be considered that the states P1-P15 are in the same state as the case where a single dirty bit is stored in the cache memory lines LW(0)-LW(n). Accordingly, the state P1-P15 can be considered to be the states where a single dirty bit is valid.

The replace-way selecting priority becomes as follows in the sate where a single dirty bit is stored in each one of the cache memory lines LW(0)-LW(n). That is, when the bus load judging device 30 judges in this state that the bus load is valid, the replace-way is so selected that the bus load at the time of replacement becomes small. Therefore, the way is selected in order from the way in the state of P0 where the dirty bit is invalid to the ways in the states P1- P15 where the dirty bits are valid. In the meantime, when the bus load judging device 30 judges in this state that there is no bus load, the priority is reversed. Thus, the way is selected in order from the ways in the states of P1-P15 where the dirty bits are valid and to the way in the state of P0 where the dirty bit is invalid. When there are a plurality of ways of the same priority, the way is selected in order from the one with the smallest way number.

(Replacement Processing)

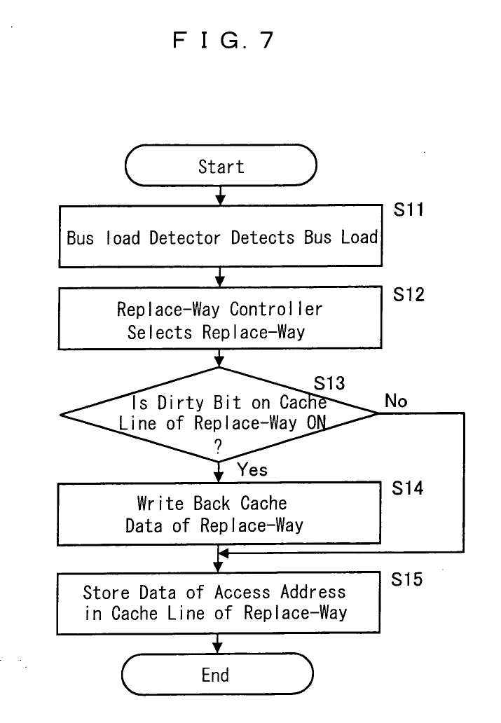

FIG. 7 shows a flowchart of the replacement processing performed in the cache memory system of this embodiment. When there is an access from the CPU 10 and there is a cache error, the bus load judging device 30 detects the bus load (S11).

Next, the replace-way controller 40 determines the replace-way (S12). The details thereof have been described by referring to FIG. 6.

Then, if the dirty bit in the cache memory line of the replace-way is ON, it proceeds to a step S14 and, if the dirty bit is not ON, it proceeds to a step S15 (S13).

When the dirty bit in the cache memory line of the replace-way is ON, the cache memory data of the replace-way is written back (S14)

After the write-back processing is performed in the step S14 and it is judged in the step S13 that the dirty bit is not ON, the data of access address from the CPU 10 is stored to the cache memory line of the replace-way (S15). Thereby, the replacement processing is completed.

(Selection of Replace-Way)

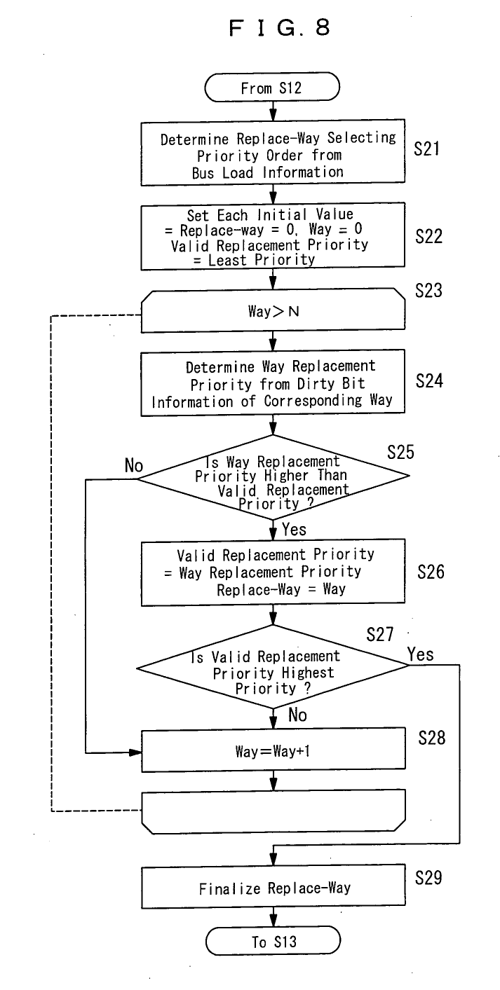

FIG. 8 shows a flowchart of replace-way selecting processing performed by the replace-way controller 40, which is described in the step 12 of FIG. 7. First, based on the bus load information supplied from the bus load judging device 30, the replace-way selection priority is determined (S21).

Then, each of the initial values of the replace-way, way, and valid replacement priority is set. The replace-way is a way to be replaced and the initial value thereof is 0. The way is the corresponding way to be processed in the following step and the initial value thereof is 0. The valid replacement priority is the replacement priority of the replace-way, and the initial value thereof is the least priority in the replace-way selection priority order determined in the step S21 (S22).

Subsequently, when the cache memory 20 is an N-way set associative cache memory, judgment is made on whether or not it has reached way N. When it is judged that it has reached the way N, loop processing of FIG. 8 is ended (S23). When it is judged in the step S23 that it has not reached the way N, the loop processing of FIG. 8 is continued thus proceeding to a step S24.

In the step S24, the way replacement priority is determined from the dirty bit information of the corresponding way. The dirty bit information of the corresponding way shows the state (ON/OFF) of the dirty bit of the corresponding way, that is, the states P0-P15 in FIG. 6. The replace-way priority is the replacement priority which is obtained form the dirty bit information of the corresponding way described above.

Next, the way replacement priority obtained by the processing of the step S24 is compared to the valid replacement priority (S25). When it is judged in the comparing processing of the step S25 that the way replacement priority is higher than the valid replacement priority, it proceeds to a step S26. When it is judged that the way replacement priority is lower, it proceeds to a step S28.

Then, the way replacement priority is substituted to the valid replacement priority, and the way is substituted to the replace-way (S26).

Next, it is judged whether or not the valid replacement priority obtained in the step S26 is the highest priority in the replace-way selection priority order which is determined in the step S21 (S27). When it is judged as NO (not the highest priority) in the processing of the step S27, it proceeds to the step S28 and, when it is judged as YES (the highest priority), it proceeds to a step S29 (S27).

In the step S28, after adding one way, it returns to the step S23 which judges whether or not to end the loop processing.

In the step S29, the replace-way obtained in the step S26 is finalized as the replace-way and the processing is ended.

(Effect)

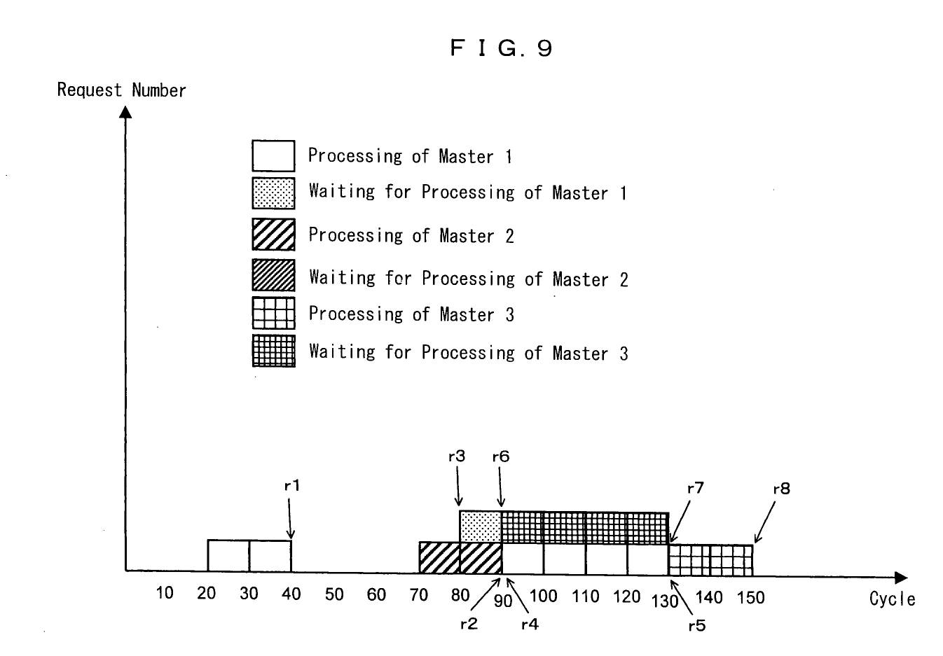

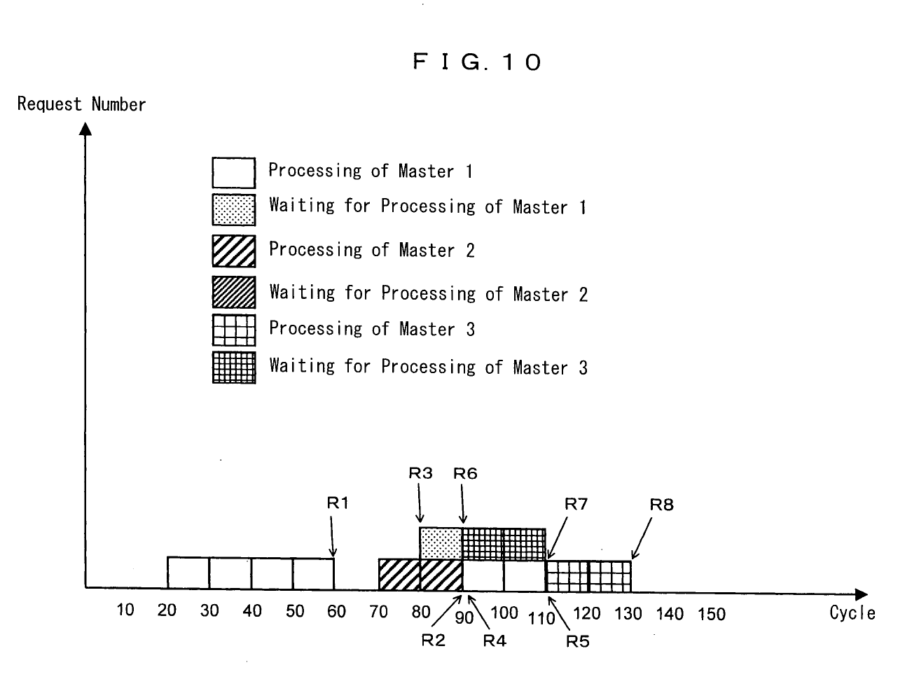

The effects of the cache memory of this embodiment will be described by referring to FIG. 9 and FIG. 10. FIG. 9 and FIG. 10 show the processing of masters M1-M3 where the horizontal axis is the time (cycle) and the vertical axis is the request number for the bus. Each of the masters M1-M3 has a write-back system cache memory 20 in a 4-way set associative system.

FIG. 9 shows, as a comparative example, a processing result of a general cache memory system which performs replacement by giving priority to a way which is not exclusive-discordant. FIG. 10 shows the processing result of the cache memory system of this embodiment.

The processing results shown in FIG. 9 and FIG. 10 are the data when the processing is carried out under the following condition.

The processing of FIG. 9 and FIG. 10 is carried out on assumption of the following condition.

The condition setting value D3 of the bus load judging condition setting unit 32 in the cache memory system is set as “1”, and it is judged that the bus load is valid when the bus request reserved number N1 at the time of cache error is “1” or more.

There are a single datum which is not exclusive-discordant and three data which are exclusive-discordant on the way of the cache memory 20 of the master M1.

There are four data which are not exclusive-discordant on the way of the cache memories 20 of the master M2 and the master M3.

At the 20th cycle and the 80th cycle, there are replacement processing requests of the master M1 generated due to a cache error caused by writing.

At the 70th cycle, there is a replacement processing request of the master M2 generated due to cache error caused by writing.

At the 90th cycle, there is a replacement processing request of the master M3 generated due to cache error caused by writing.

The replacement processing without write-back requires 20 cycles.

The replacement processing with write-back requires 40 cycles.

After performing the above-described processing, the comparative example can obtain the result, which is shown in FIG. 1 and described in the followings.

The way of exclusive-discordant is selected by the replacement processing in the 20th cycle by the master M1, the replacement processing without write-back is performed, and the processing is completed at the 40th cycle (r1).

In the replacement processing of the master M2 at the 70th cycle, the replacement processing without write-back is started, and the processing is completed at the 90th cycle (r2).

Although the replacement processing of the master M1 is generated at the 80th cycle (r3), execution of the processing thereof is held until the 90th cycle where the replacement processing of the master M2 is completed (r4).

The replacement processing of the master M1 is started from the 90th cycle (r4). However, at this time, there is only the data of exclusive-discordant remained in the cache memory 20 of the mater M1. Thus, the replacement processing with write-back is performed and the processing is completed at 130th cycle (r5).

Although the replacement processing of the master M3 is generated at the 90th cycle (r6), execution of the processing thereof is held until the 130th cycle where the replacement processing of the master M1 is completed (r5).

The replacement processing without write-back is started from the 130th cycle (r7), and the processing is completed at 150th cycle (r8).

In the above-described processing, the entire replacement processing is completed at the 150th cycle.

In the meantime, this embodiment achieves the result which is shown in FIG. 10 and described in the followings.

In the replacement processing by the master M1 at the 20th cycle, there is no load in the bus due to the other maters. Thus, the way of exclusive-discordant is selected, the replacement processing with write-back is performed, and the processing is completed at the 60th cycle (RI).

The replacement processing without write-back is performed at the 70th cycle, and the processing thereof is completed at the 90th cycle (R2).

Although the replacement processing of the master M1 is generated at the 80th cycle (R3), execution of the processing thereof is held until the 90th cycle where the replacement processing of the master M2 is completed (R2).

The replacement processing of the master M1 is started from the 90th cycle (R4). However, the replacement processing of the master M2 is performed upon the request of the replacement processing at the 80th cycle, so that the bus request reserved number N1 is “1”. Thus, the bus load is judged as valid. Based on the judgment, the way of exclusive-discordant is selected and the replacement processing without write-back is performed. The processing is completed at the 110th cycle (R5).

Although the replacement processing of the master M3 is generated at the 90th cycle (R6), execution of the processing thereof is held until the 110th cycle where the replacement processing of the master M1 is completed (R5).

The replacement processing without write-back is performed at the 110th cycle (R7), and the processing thereof is completed at the 130th cycle (R8).

In the above-described processing, the entire replacement processing is completed at the 130th cycle.

As clear from the above, the processing time of the cache memory system of this embodiment is shortened by 20 cycles compared to the comparative example.

(Moving Picture Processor)

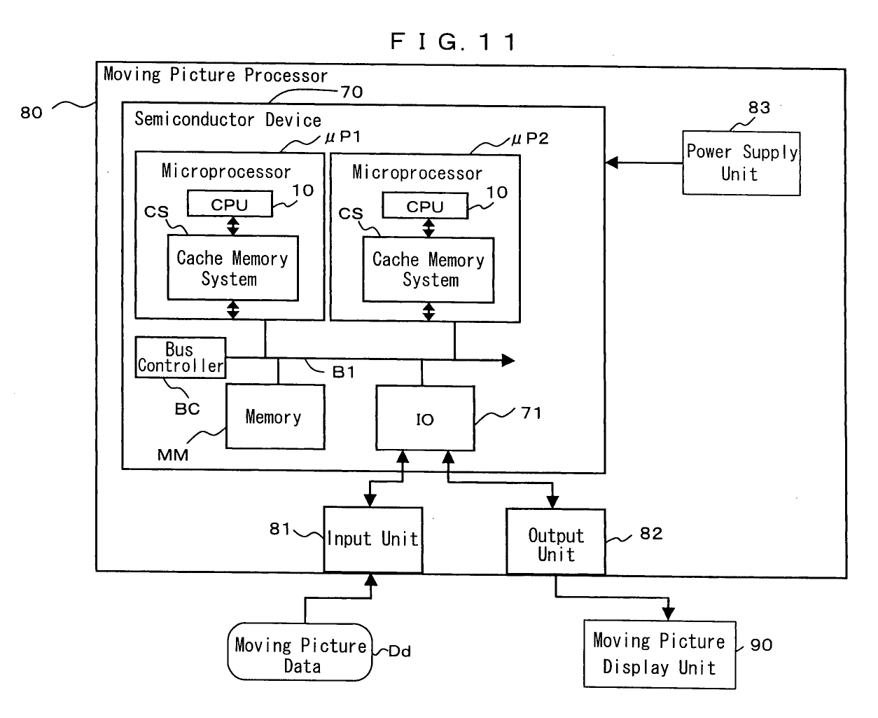

FIG. 11 is a block diagram for showing the structure of a moving picture processor according to the embodiment of the present invention. This moving picture processor 80 comprises a semiconductor device 70, an input unit 81 for inputting moving picture data Dd, an output unit 82 for outputting the moving picture image to a moving picture display unit 90, and a power source unit 83.

The semiconductor device 70 comprises microprocessors μP1, μP2, a bus controller BC, a memory (master memory) MM, a bus B1, and an IO interface 71.

Each of the microprocessors μP1, μP2 comprises the cache memory system of the present invention and a CPU (controller) 10. The microprocessor μP1 mainly controls the entire device, while the microprocessor μP2 mainly controls the moving picture processing.

(Flow of Moving Picture Processing)

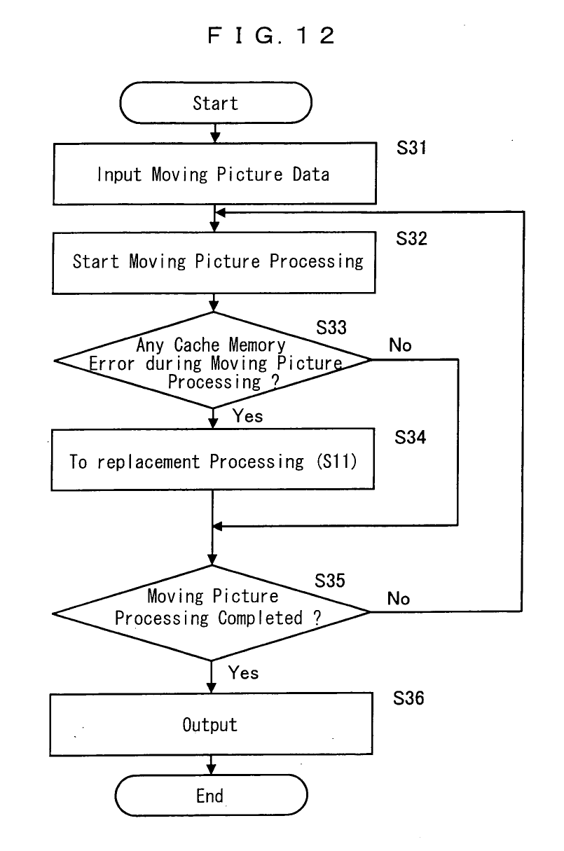

FIG. 12 shows the flow of moving picture processing performed by the moving picture processor. First, moving picture data Dd of DVD-VIDEO or the like is inputted from the input unit 81 (S31). When the moving picture data Dd is inputted from the input unit 81 in the step S31, the microprocessor μP1 gives a command to the microprocessor μP2 to perform moving-picture processing on the moving picture data. Upon receiving the command, the microprocessor μP2 starts the moving-picture processing (S32). When the moving-picture processing is started, it is judged whether or not there is cache error to be generated during the moving-picture processing performed by the microprocessor μP2 (S33).

When it is judged in the step S33 that cache error is to be generated (S33), the cache memory system CS performs the replacement processing of the step S11 shown in FIG. 7 (S34).

The replacement processing of the step S34 (the step S11) varies according to the judgment of the bus load of the bus B1. That is, at the time of having a cache error, if there is no memory access by the microprocessor μP1 and the bus load of the bus B1 is judged as invalid, the replacement processing for effectively using the bus B1 is carried out. In the meantime, at the time of having a cache error, if there is a memory access by another microprocessor μP1 and the bus load of the bus B1 is judged as valid, the replacement processing with smaller load on the bus B1 is carried out.

When the replacement processing of the step S34 is completed or when it is judged that there is no cache error generated during the moving-picture processing of the step S33, it is determined at this point whether or not the moving-picture processing is completed (S35). If it is judged in the processing of the step S35 that the moving-picture processing is completed, the moving-picture data to which the processing is completed is outputted from the output unit 82 to the moving-picture display unit 90(S36). Thereby, the processing with a series of steps is completed. In the meantime, if it is judged in the step S35 that the moving-picture processing is not completed, it returns to the step S32 for repeating the moving-picture processing.

(Effect of Preventing Moving-Picture Processing Failure Achieved by Cache Memory System)

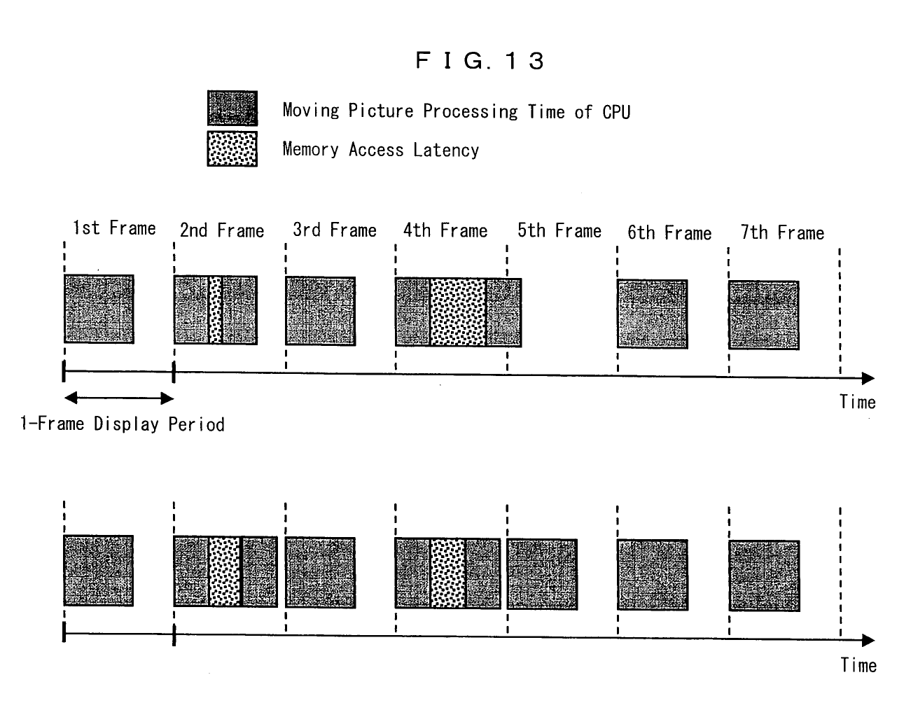

The effect of preventing the moving-picture processing failure achieved by the moving picture processor of this embodiment will be described by referring to FIG. 13. The graph of FIG. 13 on the upper side shows the state of frame processing in time sequence, which is performed by the moving picture processor to which a conventional cache memory is mounted. The graph in the lower side shows the state of frame processing in time sequence, which is performed by the moving picture processor 80 of this embodiment. The frame processing is a kind of the basic processing in the moving-picture processing, and it means to process an image, which is to be displayed next, within a display period of one frame. The state shown in FIG. 13 will be described in the followings.

The cache memory 20 has a structure of 4-way set associative system, and it is assumed that the cache memory 20 already has 3-ways of data which are exclusive-discordant and 1-way of data which is not exclusive-discordant.

In both graphs on the upper and lower sides of FIG. 13; there is latency (waiting time) of memory access generated at the 2nd frame and the 4th frame.

The memory access latency generated in the processing at the 2nd frames of the graphs of FIG. 13 on the upper and lower sides are generated as follows. That is, when there is generated cache error due to a write-access under the state where there is no memory access by other masters, the memory access latency is generated for replace-processing the data of no exclusive-discordant.

In the cache memory of the comparative example, there are data of exclusive-discordant for 4 ways on the cache memory in the above-described replacement processing. Therefore, in the processing of the 4th frame, a moving-picture failure is caused since the moving-picture processing cannot be completed in one-frame display period because of the memory access latency generated in the 2nd frame. The reason for this is that there are only the data of exclusive-discordant remained in the cache memory access since there is a cache error generated under the state having the memory access by other masters, and the replace processing with write-back is performed. Such replacement processing requires time for memory access thus causing the moving-picture processing failure.

In the cache memory system of this embodiment, in the state where there is no memory access by other masters, the replacement processing with write-back is performed by using the bus effectively. Thus, the memory access latency generated in the processing of the 4th frame is caused by the same reason as the case of the 2nd frame. In the case of this embodiment, as shown in the graph on the lower side, there is no moving-picture failure to be caused. The reason is that, in the cache memory system of this embodiment, the replacement processing without write-back is performed so as not to impose the bus load under the state where there is a memory access by other masters. With this, in the moving picture processor to which the cache memory system of this embodiment is mounted, it is possible to prevent the moving-picture processing failure by suppressing generation of the local memory access latency.

As described above, the cache memory system of the present invention is effective as a technique for making the bus traffic uniform to be used in a system in which a plurality of masters use a common bus. In this system, the replacing method is changed according to the bus load so that the bus traffic becomes uniform. Thus, it is possible to prevent generation of the local bus traffic. Therefore, the present invention can be optimally used for a moving picture processor in which a system failure such as missing of a frame, etc. is likely to be caused due to the local bus traffic. Further, it is also effective as a technique for reducing the bus width by making the bus traffic uniform.

The present invention has been described in detail by referring to the most preferred embodiments. However, various combinations and modifications of the components thereof are possible without departing from the sprit and the broad scope of the appended claims.

What is claimed is:

1. A cache memory system, comprising:
a cache memory;
a bus load judging device for performing judgment of a state of a bus that is connected to a recording device in which cache-target data of said cache memory is stored; and
a replace-way controller for controlling a replacing form of said cache memory according to a result of said judgment performed by said bus load judging device.

2. The cache memory system according to claim 1, wherein said cache memory is a cache memory in a multi-way set associative system.

3. The cache memory system according to claim 1, wherein:
said bus load judging device sets validity/invalidity of load of said bus according to said judgment on said bus state; and
said replace-way controller controls said replacing form of said cache memory according to a set state of said bus load judging device.

4. The cache memory system according to claim 3, wherein said replace-way controller performs replacement by giving priority to a way which is not exclusive-discordant when said bus load is judged as valid by said bus load judging device, while performing replacement by giving priority to a way which is exclusive-discordant when said bus load is judged as invalid.

5. The cache memory system according to claim 3, wherein said bus load judging device comprises:
a bus load information holding unit which gathers and holds bus request reserved number of said bus;
a bus load judging condition setting unit for setting a condition for judging (referred to as judging condition herein after) said bus load in said bus request reserved number which is being gathered and held; and
a comparator which compares said bus request reserved number held in said bus load information holding unit and said judging condition set in said bus load judging condition setting unit and, according to a result of comparison performed thereby, sets validity/invalidity of said load of said bus.

6. The cache memory system according to claim 5, wherein said comparator judges said bus load as valid when said bus request reserved number is larger or equal to said judging condition, and judges as invalid for other cases.

7. The cache memory system according to claim 3, wherein said bus load judging device comprises a bus load presence information setting unit which can set presence of said bus load from outside of said device, said bus load judging device judging validity/invalidity of said bus load according to a set state of said bus load presence information setting unit.

8. The cache memory system according to claim 7, wherein said bus load presence information setting unit sets presence of said bus load according to information indicating validity or invalidity of said bus load, which is written on a program.

9. The cache memory system according to claim 3, wherein:
said cache memory comprises a plurality of cache memory lines; and
under a state where there are a plurality of dirty bits indicating exclusive-discordant in each of said cache memory lines of said cache memory, said replace-way controller performs replacement by giving priority to a way having less valid number of said dirty bits when said bus load is judged as valid by said bus load judging device, while performing replacement by giving priority to a way having more valid number of said dirty bits when judged as invalid.

10. The cache memory system according to claim 3, wherein:
said cache memory comprises a plurality of cache memory lines; and
under a state where burst transfer can be executed in said cache memory, said replace-way controller changes a way to be replaced in accordance with setting of said burst transfer of said cache memory and distributions of valid dirty bits when there are a plurality of dirty bits indicating exclusive-discordant in each of said cache memory lines and numbers of said valid dirty bits are consistent with each other.

11. A moving picture processor which processes inputted data and output it as moving picture data, said processor comprising:
a cache memory;
a bus load judging device for performing judgment of a state of a bus that is connected to a recording device in which cache-target data of said cache memory is stored;
a replace-way controller for controlling a replacing form of said cache memory according to a result of said judgment performed by said bus load judging device;
a controller for making an access to said cache memory;
a recording device for recording a command of said controller or said data;
a bus for transferring said command or said data between said controller and said recording device; and
a bus controller for outputting information regarding said bus load to said bus load judging device.

12. The moving picture processor according to claim 11, wherein said cache memory is a cache memory in a multi-way set associative system.

13. The moving picture processor according to claim 11, wherein:
said bus load judging device sets validity/invalidity of load of said bus according to said judgment on said bus state; and
said replace-way controller controls said replacing form of said cache memory according to a set state of said bus load judging device.

14. The moving picture processor according to claim 13, wherein said replace-way controller performs replacement by giving priority to a way which is not exclusive-discordant when said bus load is judged as valid by said bus load judging device, while performing replacement by giving priority to a way which is exclusive-discordant when said bus load is judged as invalid.

15. The moving picture processor according to claim 13, wherein said bus load judging device comprises:
a bus load information holding unit which gathers and holds bus request reserved number of said bus;
a bus load judging condition setting unit for setting a condition for judging (referred to as judging condition herein after) said bus load in said bus request reserved number; and
a comparator which compares said bus request reserved number held in said bus load information holding unit and said judging condition set in said bus load judging condition setting unit and, according to a result of comparison performed thereby, sets validity/invalidity of said load of said bus.

16. The moving picture processor according to claim 15, wherein said comparator judges said bus load as valid when said bus request reserved number is larger or equal to said judging condition, and judges as invalid for other cases.

17. The moving picture processor according to claim 13, wherein said bus load judging device comprises a bus load presence information setting unit which can set presence of said bus load from outside of said device, said bus load judging device judging validity/invalidity of said bus load according to a set state of said bus load presence information setting unit.

18. The moving picture processor according to claim 17, wherein said bus load presence information setting unit sets presence of said bus load according to information indicating validity or invalidity of said bus load, which is written on a program.

19. The moving picture processor according to claim 13, wherein:
said cache memory comprises a plurality of cache memory lines; and
under a state where there are a plurality of dirty bits indicating exclusive-discordant in each of said cache memory lines of said cache memory, said replace-way controller performs replacement by giving priority to a way having less valid number of said dirty bits when said bus load is judged as valid by said bus load judging device, while performing replacement by giving priority to a way having more valid number of said dirty bits when judged as invalid.

20. The moving picture processor according to claim 13, wherein:
said cache memory comprises a plurality of cache memory lines; and
under a state where burst transfer can be executed in said cache memory, said replace-way controller changes a way to be replaced in accordance with setting of said burst transfer of said cache memory and distributions of valid dirty bits when there are a plurality of dirty bits indicating exclusive-discordant in each of said cache memory lines and numbers of said valid dirty bits are consistent with each other.

21. A cache memory control method, comprising:
a bus load judging step for judging a state of a bus that is connected to a recording device in which cache-target data of cache memory is stored; and
a replace-way control step for controlling a replacing form of said cache memory according to a result of judgment performed in said bus load judging step.

22. The cache memory control method according to claim 21, wherein said cache memory is a cache memory in a multi-way set associative system.

23. The cache memory control method according to claim 21, wherein:
in said bus load judging step, validity/invalidity of load of said bus is set according to said judgment on said bus state; and
in said replace-way control step, said replacing form of said cache memory is controlled according to a set state which is set in said bus load judging step.

24. The cache memory control method according to claim 23, wherein, in said replace-way control step, replacement is performed by giving priority to a way which is not exclusive-discordant when said bus load is judged as valid in said bus load judging step, while replacement is performed by giving priority to a way which is exclusive-discordant when said bus load is judged as invalid.

25. The cache memory control method according to claim 23, wherein said bus load judging step includes:
a bus load information gathering step which gathers bus request reserved number of said bus;
a bus load judging condition setting step for setting a condition for judging (referred to as judging condition herein after) said bus load in said bus request reserved number which is being gathered; and
a comparing step for comparing said bus request reserved number which is being gathered and said judging condition being set and, according to a result of comparison performed thereby, sets validity/invalidity of said load of said bus.

26. The cache memory control method according to claim 25, wherein, in said comparing step, said bus load is judged as valid when said bus request reserved number is larger or equal to said judging condition, and said bus load is judged as invalid for other cases.

27. The cache memory control method according to claim 23, wherein, in said bus load judging step, validity/invalidity of said bus load is judged according to a set state of said bus load presence.

28. The cache memory control method according to claim 27, wherein, in said bus load presence information setting step, presence of said bus load is set according to information indicating validity or invalidity of said bus load, which is written on a program.

29. The cache memory control method according to claim 23, wherein:
said cache memory comprises a plurality of cache memory lines; and
under a state where there are a plurality of dirty bits indicating exclusive-discordant in each of said cache memory lines of said cache memory, said replace-way control step performs replacement by giving priority to a way having less valid number of said dirty bits when said bus load is judged as valid by said bus load judging step, while performing replacement by giving priority to a way having more valid number of said dirty bits when judged as invalid.

30. The cache memory control method according to claim 23, wherein:
said cache memory comprises a plurality of cache memory lines; and
under a state where burst transfer can be executed in said cache memory, said replace-way control step changes a way to be replaced in accordance with setting of said burst transfer of said cache memory and distributions of valid dirty bits when there are a plurality of dirty bits indicating exclusive-discordant in each of said cache memory lines and numbers of said valid dirty bits are consistent with each other.
